(19) United States
(12) Patent Application Publication
(10) Pub. No.: US 2006/0024465 A1
(43) Pub. Date: Feb. 2, 2006

(54) Laminate flooring members

(76) Inventor: Jean Briere, Ooltewah, TN (US)

Correspondence Address: NEEDLE & ROSENBERG, P.C., SUITE 1000, 999 PEACHTREE STREET, ATLANTA, GA, 30309-3915, US

(21) Appl. No.: 11/193,866

(22) Filed: Jul. 29, 2005

Related U.S. Application Data
(60) Provisional application No. 60/592,967, filed on Jul. 30, 2004.

(51) Int. Cl. B32B 23/02; B32B 37/00

(52) U.S. Cl. 428/60; 428/192; 156/60

(57) ABSTRACT

A decorated flooring member constructed using the DPL process and comprises a high density fiberboard (“HDF”) core and a wear layer that has an EPLF rating of AC5. In operation, the flooring member of the present invention will exhibit similar characteristics to an HPL constructed flooring member while retaining the cost benefits of a DPL constructed flooring member.

This application claims priority to and the benefit of U.S. Patent Application No. 60/592,967, entitled “Laminate Flooring Members,” filed on Jul. 30, 2004, which is incorporated in its entirety in this document by reference.

### FIELD OF THE INVENTION

The present invention relates generally to flooring panels for use in commercial, industrial, or residential environments. More particularly, this invention relates to wear resistant decorative laminate flooring members.

### BACKGROUND OF THE INVENTION

Laminated constructs for structural and decorative use in the building and home improvement trades are now widely accepted throughout the industry for a wide range of applications. Notably, laminated engineered wood flooring is now replacing conventional, natural wood flooring due to enhanced uniformity, durability, and appearance while facilitating installation and maintenance.

Laminate flooring members are typically constructed using one of two conventional processes: a direct pressure laminate process (“DPL”) and a high pressure laminate process (“HPL”). The difference between the two processes is in how the layered materials are attached to the core. The DPL process is an extended one step process, whereby all the layers of the laminate flooring member are fused directly to the core at the same time, and impregnated with a resin, such as, for example, an aluminum oxide/melamine resin, using heat and pressure. The HPL process utilizes a two step wear layer process. First, craft paper type sheets are glued together along with a print film, which is then glued to the core to form a glued-up construct. Subsequently, the glued-up construct is bonded together under pressure.

Laminated flooring members typically comprise a decorative surface layer, a core, a balancing backing, and a wear layer, which are bonded together. The decorative surface layer can be made of a resin, such as, for example a melamine/aluminum oxide based resin. The decorative surface layer is typically bonded to a moisture resistant core that can be formed from, for example, a wood composition. The balancing backing layer is bonded to the underside of the core. To protect the top of the flooring member, the wear layer is applied to provide protection and stain resistance.

Conventional cores are made of high or medium density fiberboard saturated in resins to make them extremely hard. This allows the flooring members to be cut with an edge profile, such as a tongue and complementary groove, as desired, for ease of installation.

Although the core materials are conventionally saturated in resins, the floor members can still swell from excessive amounts of moisture. The balancing backing layer is applied to the underside of the core to help stabilize the flooring member and to act as another barrier from moisture trying to enter the flooring member from below. Most manufacturers saturate this backing layer with resins to resist moisture and to make the balancing backing layer more dimensionally stable. In conventional construction, flooring members with such a resin filled balancing backing layer are not typically glued directly to the sub floor.

The top layer, or wear layer, is typically clear, such that the aesthetic appearance, including any color and/or printed image of the decorative layer, is not obscured by the wear layer. The Association of European Producers of Laminate Flooring (EPLF) has adopted a standards based rating system to rate the wear layers of laminate floor products, which helps buyers understand the differences in durability among laminate floor products. These standardized tests combine the Tabor Abrasion Test, impact resistance, stain resistance, burn resistance, and the effects of furniture legs or castors and thickness swelling along element edges. Even if a product fails to comply with only one single rating, approval for the level of use in question is denied. The ratings are as follows:
AC2 (Moderate Residential): This is the lowest rating and these floors are suitable only for moderate residential use such as a bedroom;
AC3 (General Residential): Suitable for “normal residential” applications such as living rooms and dining rooms;
AC4 (General Commercial): Suitable for all residential applications plus general commercial applications such as offices, boutiques and cafe's; and
AC5 (Heavy Commercial): Suitable for all residential applications plus heavy commercial applications such as public buildings, department stores, etc.

Typically, flooring members constructed using the HPL process are more durable, exhibit less edge chipping, better moisture resistance, and higher impact resistance than flooring members constructed using the DPL process. Since the manufacturing process is much more involved, HPL flooring members are also much more expensive and take longer to produce than DPL flooring members.

### SUMMARY

The present invention is a decorated flooring member including a core having a top surface and an opposite bottom surface. A decorative layer is adhered to the top surface of the core. A desired aesthetic appearance, such as the appearance of a hardwood or ceramic tile, can be displayed on the decorative layer of the laminate. Finally, a wear layer is provided over the decorative layer, substantially covering the decorative layer and providing protection from the ambient environment.

The floor member of the present invention is constructed using the DPL process and comprises a high density fiberboard (“HDF”) core and a wear layer that has an EPLF rating of AC5. In operation, the flooring member of the present invention will exhibit similar characteristics to an HPL constructed flooring member while retaining the cost benefits of a DPL constructed flooring member.

### DETAILED DESCRIPTION OF THE FIGURES

These and other features of the embodiments of the invention will become more apparent in the following detailed description in which reference is made to the appended drawings wherein:

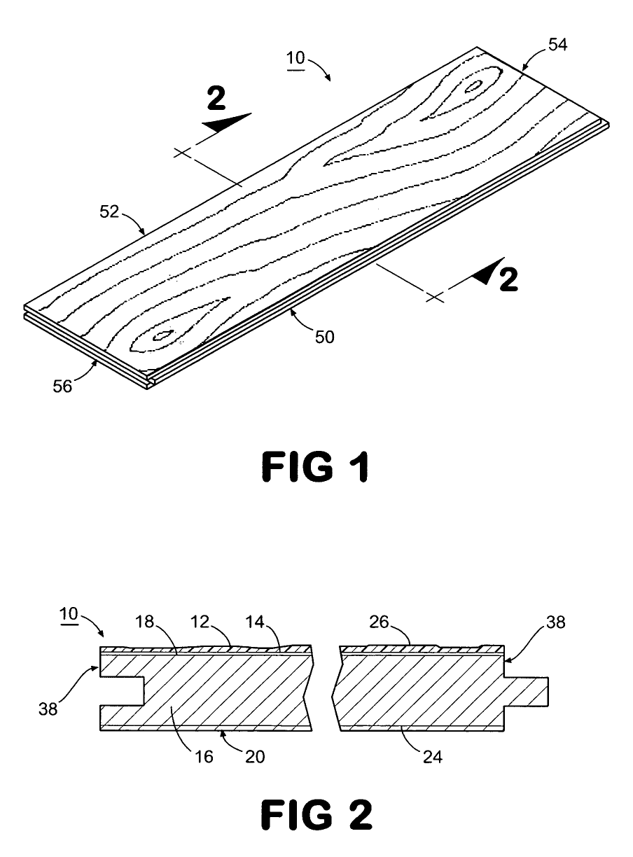

FIG. 1 is a perspective view of an embodiment of the laminated flooring member according to the present invention.

FIG. 2 is a section taken along lines 2-2 in FIG. 1.

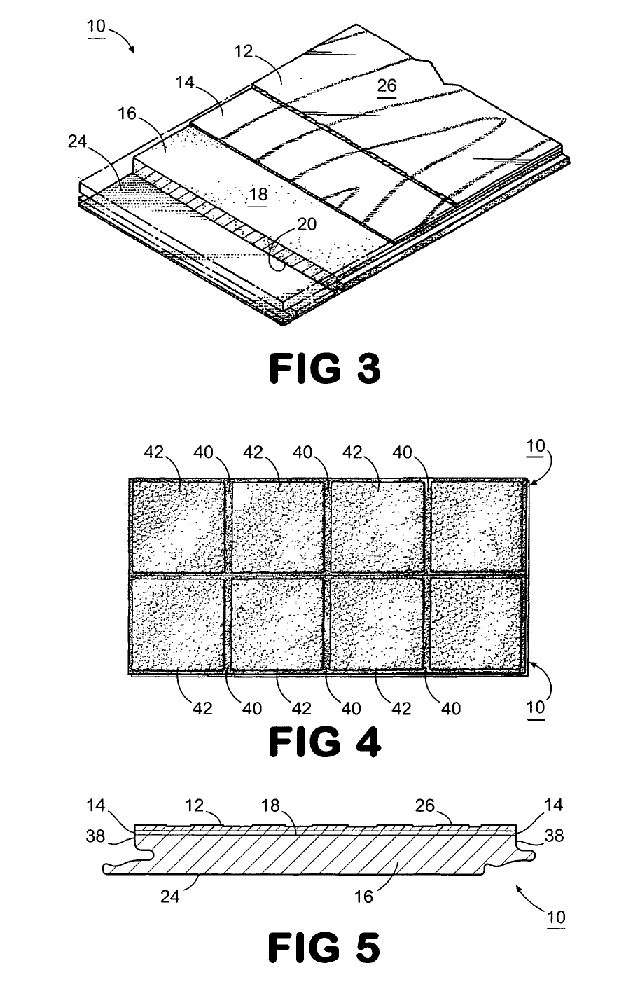

FIG. 3 is a perspective cut-away view of an embodiment of the laminated flooring panel according to the present invention.

FIG. 4 is a perspective view of a plurality of the laminated flooring members of the present invention assembled to form a portion of a floor system.

FIG. 5 is a cross-sectioned side elevational view of the laminated flooring panel according to the present invention, showing a “snap fit” tongue and groove side profile on the peripheral edges of the substrate.

### DETAILED DESCRIPTION OF THE INVENTION

Before the present articles, devices, assemblies and/or methods are disclosed and described, it is to be understood that this invention is not limited to the specific articles, devices, assemblies and/or methods disclosed unless otherwise specified, as such may, of course, vary. It is also to be understood that the terminology used herein is for the purpose of describing particular embodiments only and is not intended to be limiting.

As used herein, the singular forms “a,” “an” and “the” include plural referents unless the context clearly dictates otherwise. The embodiments are described with reference to the figures, in which like numbers indicate like parts throughout the figures.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Referring to FIGS. 2-3, the present invention, in one embodiment, is a laminated flooring member 10. In the illustrated embodiment, the laminated flooring member 10 is manufactured from natural, recycled, synthetic materials, and/or the like. The flooring member 10 comprises a plurality of discrete layers, including a wear layer 12, a decorative layer 14, a core 16 and a backing balancing layer 24. In one aspect, the core 16 can comprise fiberboard. In one embodiment of the invention, the core comprises high density fiberboard having a density of about and between 850 kg/m³ to about 1100 kg/m³, more particularly about and between 900 kg/m³ to about 1050 kg/m³, and still more particularly about and between 920 kg/m³ to about 1000 kg/m³. In an additional aspect, the core has a maximum thickness swelling of about and between 6% to about 10%, more particularly about and between 7% to about 9%, and still more particularly less than or about 8%. In a further aspect, the core will have an internal bond and a surface bond of about and between 1.6 N/m³ to about 2.1 N/m³, more particularly about and between 1.75 N/m³ to about 1.95 N/m³, and still more particularly greater than or about 1.8 N/m³.

In one aspect, the core will preferably have a modulus of rupture of about and between 30 N/m³ to about 60 N/m³, more particularly about and between 35 N/m³ to about 55 N/m³, and still more particularly greater than or about 45 N/m³. In another aspect, the preferred modulus of elasticity of the core of the flooring member is about and between 3500 N/m³ to about 6000 N/m³, more particularly about and between 4200 N/m³ to about 5200 N/m³, and still more particularly greater than or about 4500 N/m³. In other contemplated embodiments, cores 16 of different materials or having different properties may be utilized, including, for example and not meant to be limiting, other timber-based products, such as, for example, plywood, chipboard, particleboard, or the like. In one example, the core material has an overall thickness of about and between 7.5 mm to about 8 mm and is available in conventional lengths and widths.

The core 16 has a top surface 18 and an opposite bottom surface 20. When installed, the bottom surface 20 of the core 16 faces the underlying subfloor (not shown). FIG. 3 illustrates an embodiment having an optional backing balancing layer 24 that is connected to the bottom surface 20 of the core 16. Because some conventional core materials are not completely impervious to moisture and contaminants, such a backing balancing layer 24 can be provided to improve moisture resistance of the floor panel 10. Additionally, the backing balancing layer 24 may improve structural integrity of the floor panel 10 by increasing overall thickness and reducing the warp and wear tendencies of uncoated core material. In one aspect, a clear backing balancing layer 24 of melamine, reinforced with aluminum oxide (Al₂O₃) and impregnated with a thermosetting resin, is applied to the bottom surface of the core. In such an embodiment, an optional layer (not shown) may be interposed between the bottom surface 20 of the core 16 and the backing balancing layer 24. In one embodiment, the optional layer is constructed of paper. The optional layer may display a printed image, such as a trademark, product number or name, or any other desired marking or designation. In other embodiments, backing balancing layers 24 may be constructed of other materials providing suitable moisture resistance, such as, for example and not meant to be limiting, phenolic resins or other natural, synthetic or recycled materials.

A decorative layer 14 is adhered, joined, or connected to the top surface 18 of the core 16 by a chemical adhesive, mechanical connection, or other means known in the art. In the illustrated embodiment, the decorative layer 14 is a sheet of paper that substantially covers the top surface 18 of the core 16. Thus, in the illustrated embodiment, the top and bottom surfaces 18, 20 of the core 16 are covered by the decorative layer 14 and the backing balancing layer 24, respectively. The upper surface 15 side of the decorative layer 14, i.e., the visible side not adhered to the core 16, is capable of displaying a desired aesthetic appearance, such as a color or pattern. Virtually any color or pattern may be imparted to the decorative layer 14. For example, currently contemplated patterns include simulated hardwood flooring and simulated ceramic tile, each in a variety of styles, shades and colors. Exemplary wood styles include pine, heart pine, cherry, maple, beech, oak, mahogany and the like. Simulated tile appearances are contemplated in a range of styles, including a variety of marble and ceramic tile colors. Inclusion of grout lines in ceramic tile styles are contemplated. Other examples of patterns include floral patterns, abstract designs, geometric designs and company logos. Of course, it is contemplated that other patterns may be selected by the manufacturer or the installer according to aesthetic preference or design objectives.

In one embodiment, the decorative layer 14 is manufactured from paper that is impregnated with a thermosetting resin and provided with the desired aesthetic color and/or pattern. In other embodiments that are not shown, other materials may make up the decorative layer 14, such as real wood veneer, pulverized stone, or other materials. Additionally, it is possible to achieve a similar decorative appearance by either a direct or indirect printing process directly onto the top surface 18 of the core 16. In such an embodiment, the decorative layer 14 comprises the marking materials, such as, for example, ink, dye, pigment or the like, that is directly applied to the top surface of the core 16. Alternatively, the decorative appearance may be provided by etching, burning or otherwise marring the top surface 18 of the core 16. Thus, it is contemplated that the decorative layer 14 comprises any treatment that supplies a decorative appearance on the top surface 18 of the core 16.

A wear layer 12 overlies the upper surface of the decorative layer 14 and substantially covers the upper surface of the decorative layer 14. The wear layer provides protection from the ambient environment. The wear layer 12 is adhered, joined, or connected to the decorative layer 14. In one aspect, the wear layer is adhered to the decorative layer similar to the methodology as the decorative layer 14 is joined to the underlying core 16. In one embodiment, the wear layer 12 is comprised of a melamine sheet, reinforced with aluminum oxide (Al₂O₃) and impregnated with a thermosetting resin. The wear layer 12 of the preferred embodiment has an EPLF rating of AC5, which is suitable for residential and commercial applications. An AC5 rating indicates that the wear layer 12 can typically withstand at least 6500 cycles on the Taber Abrasion Test before wearing through and potentially exposing the decorative layer 14.

In one aspect, the material selected to comprise the wear layer 12 can be the same or similar material as that selected to comprise the backing balancing layer 24, if a backing balancing layer 24 is utilized. Using “matched” materials for those layers can aid in minimizing “warping” and/or “bowing” of the laminate flooring member.

In an alternative aspect, a layer of varnish or a UV curable scratch resistant coating having an AC5 can be used in place of the melamine sheet to comprise the wear layer 12. As further alternatives aspects, other materials providing suitable moisture resistance and resilience to loads and wear to which a floor is subjected may be utilized, such as, for example and not meant to be limiting, phenolic resins or other natural, synthetic or recycled materials.

In one example, after manufacture of the laminate material, the wear layer 12 is substantially transparent, so that the aesthetic appearance of the decorative layer 14 is substantially unobstructed by the wear layer 12. In one aspect of the invention, the wear layer 12 is the outermost layer of the laminate flooring member and generally acts to improve the resistance of the floor panel 10 to wear, including staining or fading of the aesthetic image imparted to the underlying decorative layer 14.

In another example, as illustrated in patent application Ser. No. 10/995,971, which is incorporated in its entirety herein by reference and has commonality of assignee with the present application, the top face 26 of the wear layer may be provided with a textured surface condition. Thus, in addition to the decorative aesthetic image displayed by the decorative layer, further aesthetic effect may be achieved by imparting depressions of a constant or variable depth to the top face 26 of the wear layer, arranged to display a desired texture pattern. For example, a texture pattern featuring depressions designed to simulate wood grain may be provided. As a further example, in an embodiment in which the decorative pattern is a simulated ceramic tile having tile portions surrounded by grout lines, a texture pattern having an irregular simulated stone texture and roughened or non-smoothed depressions to simulate recessed grout may be provided. These examples are merely illustrative and are not intended to be exhaustive.

The direct pressure laminating (“DPL”) process is well known. During the manufacturing process, in one embodiment, the various separate layers are assembled in preparation for lamination. In the embodiment shown in FIG. 3, for example, direct pressure laminates are typically fabricated from a core 16, which is a medium density or a high density fiberboard or chipboard. Then, one or more kraft paper sheets impregnated with selected resins are used as the backing balancing layer 24 and are located on and/or under the core 16. Then, a decorative cellulose paper sheet 14 about 0.15 mm thick and impregnated with a melamine solution is placed on the kraft paper sheet. Over the decorative cellulose paper sheet 14 is one or more protective overlay sheets 12. The overlay sheet (wear layer) is made of a highly resistant paper having corundum (AL2 O3) impregnated in a melamine solution. It is also possible to include different papers between the decorative layer and the core. The entire structure is then pressed under heat (180-220 degree C.) and pressure of about 100 psi to 800 psi until the resins thermoset. More specifically, the structure is pressed under pressure from about 200 psi to 700 psi. Even more specifically, the structure is pressed under pressure of about 450 psi. The result is an extremely hard and permanent product called a “direct-pressure laminate (DPL)”

As illustrated in FIG. 5, individual flooring members 10 according to the invention may be assembled to form a complete floor system. To facilitate assembly, individual flooring members 10 can be provided with means for interlocking with adjacently placed panels. As shown in FIG. 2, each flooring member 10 can include a first pair of parallel sides 50, 52 having tongue and groove cuts along the first and second parallel sides 50, 52, respectively. Each such flooring member 10 further includes a second pair of parallel sides 54, 56, perpendicular to each of the first pair of parallel sides 50, 52, also having tongue and groove cuts. Thus, each such floor panel 10 is capable of interlocking engagement with an adjacent panel. Alternatively, locking edge connections, such as that described in U.S. Pat. No. 6,006,486 to Moriau et al. (which is incorporated herein in its entirety by reference), may be utilized to form a floor covering system in which neighboring floor panels 10 are detachably secured to one another through a mechanical interlock, as shown in FIG. 5.

Along the edges of the floor system, perimeter panels (not shown) may be cut to length as needed to fit the installation environment and fitted with matching trim pieces (not shown) to provide an aesthetically attractive fit adjacent walls, stairs, doorways or other obstructions or transition areas.

The laminate flooring members of the present invention can also comprise an edge sealant layer 38 which is disposed onto at least a portion of the peripheral side edges 14 of the substrate. In one example, at least a portion of the peripheral side edges is coated with a conventional sealant, such as, for example, by conventional vacuum coating. In one example, the conventional sealant may be an oil/wax material, a polymer coating, and the like. As one will appreciate, the first and second sealant layers and the edge sealant layer are substantially impermeable to moisture.

In an exemplified embodiment, individual flooring members 10 are manufactured to a width of 11.89 inches and a length of 47.56 inches, with an approximate thickness of 5/16 inches. One skilled in the art will appreciate that other flooring member sizes are contemplated and can be used without departing from the scope of the invention.

A person skilled in the art will recognize that changes can be made in form and detail, and equivalents may be substituted for elements of the invention without departing from the scope and spirit of the invention. The present description is therefore considered in all respects to be illustrative and not restrictive, the scope of the invention being determined by the following claims and their equivalents as supported by the above disclosure and drawings.

What is claimed is:

1. A decorated floor panel comprising:
a core having a top surface and an opposite bottom surface;
a decorative layer connected to and substantially covering the top surface of the core, the decorative layer having a desired aesthetic appearance; and
a wear layer connected to and substantially covering the decorative layer for protecting the decorative layer, the wear layer having an EPLF rating of AC5.

2. The decorated floor panel of claim 1, wherein the core comprises a high density fiberboard.

3. The decorated floor panel of claim 1, wherein the core has a density from about 850 kg/m³ to about 1100 kg/m³.

4. The decorated floor panel of claim 1, wherein the core has a density from about 900 kg/m³ to about 1050 kg/m³.

5. The decorated floor panel of claim 1, wherein the core has a density from about 920 kg/m³ to about 1000 kg/m³.

6. The decorated floor panel of claim 1, wherein the core has a maximum thickness swelling from about 6% to about 10%.

7. The decorated floor panel of claim 1, wherein the core has a maximum thickness swelling from about 7% to about 9%.

8. The decorated floor panel of claim 1, wherein the core has a maximum thickness swelling less than or about 8%.

9. The decorated floor panel of claim 1, wherein the core has an internal bond and a surface bond from about 1.6 N/m³ to about 2.1 N/m³.

10. The decorated floor panel of claim 1, wherein the core has an internal bond and a surface bond from about 1.75 N/m³ to about 1.95 N/m³.

11. The decorated floor panel of claim 1, wherein the core has an internal bond and a surface bond greater than or about 1.8 N/m³.

12. The decorated floor panel of claim 1, wherein the core has a modulus of rupture from about 30 N/m³ to about 60 N/m³.

13. The decorated floor panel of claim 1, wherein the core has a modulus of rupture from about 35 N/m³ to about 55 N/m³.

14. The decorated floor panel of claim 1, wherein the core has a modulus of rupture greater than or about 45 N/m³.

15. The decorated floor panel of claim 1, wherein the core has a modulus of elasticity from about 3500 N/m³ to about 6000 N/m³.

16. The decorated floor panel of claim 1, wherein the core has a modulus of elasticity from about 4200 N/m³ to about 5200 N/m³.

17. The decorated floor panel of claim 1, wherein the core has a modulus of elasticity greater than or about 4500 N/m³.

18. The decorated floor panel of claim 1, further comprising a backing layer connected to and substantially covering the bottom surface of the core as a reinforcing element.

19. The decorated floor panel of claim 18, wherein the backing layer is substantially moisture impervious.

20. The decorated floor panel of claim 18, wherein the backing layer comprises melamine reinforced with aluminum oxide.

21. The decorated floor panel of claim 1, wherein the panel includes a first pair of parallel sides, wherein the parallel sides have tongue and groove cuts along the parallel sides to provide interlocking engagement.

22. The decorated floor panel of claim 21, wherein the panel includes a second pair of parallel sides, the second pair of parallel sides being perpendicular to each of the first pair of parallel sides and wherein the second pair of parallel sides have tongue and groove cuts to provide interlocking engagement.

23. The decorated floor panel of claim 22, further comprising an edge sealant layer disposed onto at least a portion of at least one of the sides.

24. The decorated floor panel of claim 1, wherein the decorative layer comprises paper and substantially overlies the top surface of the core.

25. The decorated floor panel of claim 1, wherein the wear layer comprises melamine reinforced with aluminum oxide.

26. The decorated floor panel of claim 1, wherein the aesthetic appearance of the decorative layer is a hardwood flooring design.

27. The decorated floor panel of claim 1, wherein the aesthetic appearance of the decorative layer is a ceramic flooring tile design.

28. The decorated floor panel of claim 1, wherein the core has a thickness from about 7.5 mm to about 8 mm.

29. The decorated floor panel of claim 1, wherein the panel has a width of about 11.89 inches.

30. The decorated floor panel of claim 1, further comprising means for connecting the core, the decorative layer, and the wear layer to form a composite structure

31. The decorative floor panel of claim 30, wherein the means for connecting the core, the decorative layer, and the wear layer comprises a DLP process that comprises a means for applying a predetermined amount of pressure to at least a portion of the wear layer, and substantially compressing the core, the decorative layer, and the wear layer together.

32. The decorated floor panel of claim 1, wherein the panel has a length of about 47.56 inches.

33. The decorated floor panel of claim 1, wherein the panel has a thickness of about 5/16 inches.

34. The decorated floor panel of claim 1, wherein the wear layer comprises a top face with depressions therein of a variable depth below the top face, the depressions being arranged to display a desired texture pattern.

35. A method of manufacturing a decorated floor panel comprising:
providing a core having a top surface and an opposite bottom surface;
adhering a decorative layer to the top surface of the core, the decorative layer having a desired aesthetic appearance;
adhering a wear layer to and substantially covering the decorative layer for protecting the decorative layer, the wear layer having an EPLF rating of AC5; and
applying a predetermined amount of pressure to at least a portion of the wear layer, substantially compressing the core, the decorative layer, and the wear layer together.

36. The method of claim 35, wherein the predetermined amount of pressure is from about 100 psi to about 800 psi.

37. The method of claim 35, wherein the predetermined amount of pressure is from about 200 psi to about 700 psi.

38. The method of claim 35, wherein the predetermined amount of pressure is about 450 psi.
